(19) United States
(12) Patent Application Publication
(10) Pub. No.: US 2023/0223019 A1
(43) Pub. Date: Jul. 13, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: KAZUKI OCHIAI, TOKYO (JP)

(21) Appl. No.: 17/997,887

(22) PCT Filed: Apr. 20, 2021
(86) PCT No.: PCT/JP2021/016050

§ 371 Date: Nov. 3, 2022

(30) Foreign Application Priority Data
May 18, 2020 (JP) 2020-086399

(51) Int. Cl. G10L 15/22; G10L 25/63; G06F 3/01

(52) U.S. Cl. CPC G10L 15/22; G10L 25/63; G06F 3/017

(57) ABSTRACT

An information processing device including a control unit that performs control not to react to a user's expression, if the user's expression includes a representation of a predetermined non-response setting, until predetermined setting conditions are satisfied and to react to the user's expression if the user's expression does not include the representation of the non-response setting.

### TECHNICAL FIELD

The present disclosure relates to an information processing device, an information processing method, and a program.

### BACKGROUND ART

Devices operating in response to a user's voice or gesture are known. Many of these devices are responsive to a starting trigger from a user. For example, “XPERIA HELLO!”(registered trademark)” of Sony Corporation enters a state of reception of a voice, e.g., a command in response to a starting word (a starting trigger with words) of “Hi, Xperia” or “Hi, Hello” from a user. Other starting words are, for example, “OK, Google” in “GOOGLE HOME (registered trademark)” of Google LLC and “Alexa” in “AMAZON ECHO (registered trademark)” of Amazon Technologies, Inc.

In such devices, a malfunction needs to be prevented. For example, in PTL1 below, processing for voice recognition of devices is properly changed on the basis of the relationship between devices having the function of voice recognition, thereby preventing a malfunction when a user is surrounded by a plurality of device using the foregoing starting words.

### CITATION LIST

### Patent Literature

[PTL 1]

JP 2016-24212A

### SUMMARY

### Technical Problem

Some of these devices, for example, robots including “AIBO (registered trademark)” of Sony Corporation and “RoBoHoN (registered trademark)” of SHARP CORPORATION do not require the starting trigger. In this case, the starting trigger is not detected. When a registered command (e.g., one of multiple commands) is detected, an operation is performed according to the command.

However, many of these devices require the starting trigger. Thus, it has not been assumed that a device requiring a starting trigger and a device not requiring a starting trigger are present in the same space (the same environment), for example, a house or a room. In the future, it is expected that such devices will be more frequently present in the same space.

Unfortunately, if such devices are present in the same space and “starting trigger+command” is issued from a user to a device requiring the starting trigger, a device operating without the starting trigger may malfunction in response to the command.

An object of the present disclosure is to propose an information processing device, an information processing method, and a program that can suppress malfunctions.

### Solution to Problem

The present disclosure is, for example, an information processing device including: a control unit that performs control not to react to a user's expression, if the user's expression includes a representation of a predetermined non-response setting, until predetermined setting conditions are satisfied and to react to the user's expression if the user's expression does not include the representation of the non-response setting.

The present disclosure is, for example, an information processing method, in which a control unit performs control not to react to a user's expression, if the user's expression includes a representation of a predetermined non-response setting, until predetermined setting conditions are satisfied and to react to the user's expression if the user's expression does not include the representation of the non-response setting.

The present disclosure is, for example, a program that causes a computer to perform an information processing method, in which a control unit performs control not to react to a user's expression, if the user's expression includes a representation of a predetermined non-response setting, until predetermined setting conditions are satisfied and to react to the user's expression if the user's expression does not include the representation of the non-response setting.

### BRIEF DESCRIPTION OF DRAWINGS

FIG. 1 is a functional block diagram illustrating a configuration example of a voice recognition device according to a first embodiment.

FIG. 2 is a flowchart for explaining a processing example of a control unit according to the first embodiment.

FIG. 3 is an explanatory drawing illustrating a use environment example of the voice recognition device according to the first embodiment.

FIG. 4 is a flowchart for explaining a processing example of a control unit according to a second embodiment.

FIG. 5 is an explanatory drawing of a state shift example according to the second embodiment.

FIG. 6 is an explanatory drawing of a state shift example according to the second embodiment.

FIG. 7 is a functional block diagram illustrating a configuration example of a voice recognition device according to a third embodiment.

FIG. 8 is a functional block diagram illustrating a configuration example of a voice recognition device according to a fourth embodiment.

FIG. 9 illustrates a configuration example of a word addition screen.

FIG. 10 is a functional block diagram illustrating a configuration example of a voice recognition device according to a fifth embodiment.

FIG. 11 is a functional block diagram illustrating another configuration example of the voice recognition device according to the fifth embodiment.

FIG. 12 is a functional block diagram illustrating a configuration example of a voice recognition device according to a sixth embodiment.

FIG. 13 is a flowchart for explaining a processing example of the control unit according to a modification example.

FIG. 14 is an explanatory drawing of a state shift example according to the modification example.

FIG. 15 is an explanatory drawing of a state shift example according to the modification example.

### DESCRIPTION OF EMBODIMENTS

Hereinafter, embodiments of the present disclosure will be described with reference to the drawings. The description will be made in the following order.
<1. First Embodiment>
<2. Second Embodiment>
<3. Third Embodiment>
<4. Fourth Embodiment>
<5. Fifth Embodiment>
<6. Sixth Embodiment>
<7. Modification Example>

The embodiments to be described below are preferred specific examples of the present disclosure and the contents of the present disclosure are not limited to the embodiments. In the following description, constituent elements having substantially the same functional configurations are indicated by the same reference numerals, and a redundant description thereof is optionally omitted.

### 1. First Embodiment

### [Configuration of Voice Recognition Device]

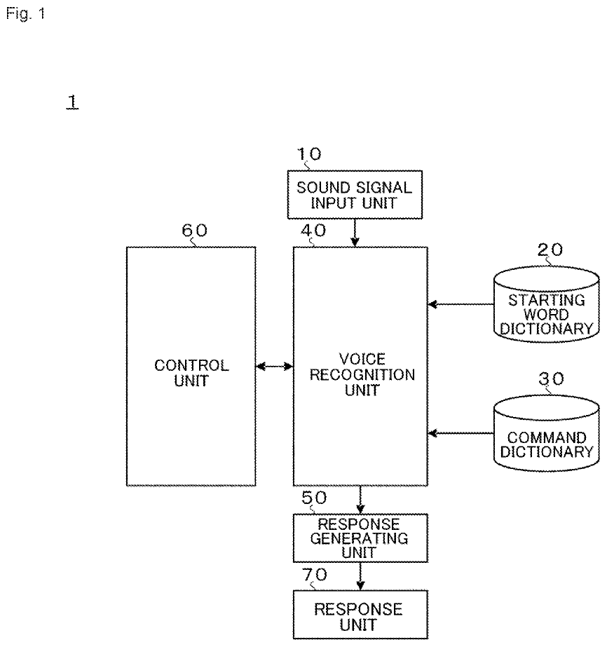

FIG. 1 is a functional block diagram illustrating a configuration example of a voice recognition device (voice recognition device 1) according to the present embodiment. As described above, the voice recognition device 1 is responsive to a user's voice. The voice recognition device 1 is provided for, for example, a robot having the function of voice recognition and a voice UI, a smart speaker/display, a smartphone, a tablet, a personal computer, other home appliances, indoor/outdoor equipment, toys, furniture, medical equipment, and a moving apparatus.

As illustrated in FIG. 1, the voice recognition device 1 includes, for example, a sound signal input unit 10, a starting word dictionary 20, a command dictionary 30, a voice recognition unit 40, a response generating unit 50, a control unit 60, and a response unit 70. The voice recognition device 1 implements the function of a basic voice UI by means of, for example, the command dictionary 30, the voice recognition unit 40, and the response generating unit 50.

The sound signal input unit 10 includes, for example one or more microphones. The sound signal input unit 10 collects a sound, e.g., a user's voice and converts the sound into a sound signal serving as information about user's expressions. The converted sound signal is provided for the voice recognition unit 40. The starting word dictionary 20 and the command dictionary 30 include, for example, storage devices (not illustrated) such as ROM (Read Only Memory) and RAM (Random Access Memory). For example, the starting word dictionary 20 and the command dictionary 30 may include different storage devices or the same storage device.

The starting word dictionary 20 stores a starting word as information about the representation of a non-response setting. The starting word means a trigger (starting trigger) using a word of an instruction to start a reaction to a voice. The starting word stored in the starting word dictionary 20 is used by devices other than the voice recognition device 1. Specifically, the starting word dictionary 20 has a list of starting words. In other words, the starting word dictionary 20 allows the setting and registration of the starting words of a plurality of devices. The number of registered starting words is not particularly limited. The starting words include, for example, “Hi, Xperia” or “Hi, Hello” for “XPERIA HELLO!”(registered trademark)” of Sony Corporation, “OK, Google” for “GOOGLE HOME (registered trademark)” of Google LLC, and “Alexa” for “AMAZON ECHO (registered trademark)” of Amazon Technologies, Inc. The starting words are stored as, for example, information (specifically, text data) about phonetic representations (for example, the representations of characters indicating the reading of Japanese). The starting words may be stored as, for example, information about typical character representations (for example, representations including kanji, kana, and alphabets in Japanese). The voice recognition device 1 is a device that does not require a starting word when reacting to a voice (specifically, performing an operation in response to a voice).

The command dictionary 30 stores words for commands as information for specifying a response. Words for commands mean words for specifying various commands for performing processing when the words are included in a user's voice. The command dictionary 30 specifically includes a list of words for commands. In other words, in the command dictionary 30, a plurality of words for commands can be set and registered. The number of registered words for commands may be one or more. Words for commands are, for example, “Play music”, “What is the weather tomorrow?” and the like. For example, from words for a command, “Play music,” a response for “playing music” (e.g., selection and playback of music) is specified. A rule for setting words for commands may be properly determined in the voice recognition unit 40, which will be described later, to the extent that commands can be detected. Words for commands are stored as, for example, information about the foregoing phonetic representations. Words for commands may be stored as, for example, information about typical character representations.

The starting word may be included as a word for a command in the command dictionary 30. In other words, the starting word may be registered as a registered word of the voice recognition device 1 while being placed in the same row as words for commands. Thus, the starting word dictionary 20 can be omitted to simplify the configuration and setting of the device. In this case, for example, the starting word is preferably registered with a flag such that the starting word can be easily identified. Thus, processing in the voice recognition unit 40, which will be described later, can be efficiently performed.

The voice recognition unit 40, the response generating unit 50, and the control unit 60 include, for example, processing units (not illustrated) such as a CPU (Central Processing Unit). The voice recognition unit 40, the response generating unit 50, and the control unit 60 read and execute programs stored in the foregoing storage devices, and perform a variety of processing. The programs may be stored in other storage devices, for example, external storages such as a USB memory, may be provided by a communication device (not illustrated) via a network, or may be partially executed by other devices via a network. The processing unit and the program may each be a single processing unit and a single program, or may include a plurality of processing units and a plurality of programs.

The voice recognition unit 40 performs voice recognition by using the sound signal acquired from the sound signal input unit 10. The processing result (recognition result) is provided to the response generating unit 50 and the control unit 60. Specifically, the voice recognition unit 40 specifies a sound section, e.g., a voice section (determined as a section with a continuous sound on the basis of a predetermined criterion) by using a known method and performs voice recognition for each of specified sound sections.

A processing example of the voice recognition unit 40 will be described below. When the sound signal is provided from the sound signal input unit 10, the voice recognition unit 40 reads and acquires the starting word from the starting word dictionary 20 and detects the starting word from the sound signal. Thus, the voice recognition unit 40 recognizes whether a voice includes the starting word. The detection result (recognition result) is provided to the control unit 60. The starting word is detected by using a known method. Words for commands are detected in the same manner as described below.

In a state (mode) of reception of a voice instruction (command), the voice recognition unit 40 reads and acquires words for a command from the command dictionary 30 and detects the words for the command from the sound signal. Thus, the voice recognition unit 40 recognizes (specifies) whether a voice includes the command. For example, when words for a command “What is the weather tomorrow?” are detected from the sound signal, the contents (instruction) are recognized as an instruction to indicate tomorrow's weather. The recognition result based on the detection result of the words for the command is provided to the response generating unit 50. The voice instruction is not limited to instructions intentionally provided by a user.

The response generating unit 50 performs processing for generating a response for a voice according to the recognition result acquired from the voice recognition unit 40. The processing result is provided to the response unit 70. In the foregoing example, the response generating unit 50 acquires information about tomorrow's weather by accessing, for example, web service for providing weather forecast information via a communication device. Subsequently, response information (e.g., voice data) including “It will be fine tomorrow” is generated in response to an inquiry “What is the weather tomorrow?”

The control unit 60 performs processing for controlling the function of a voice UI. Specifically, the control unit 60 performs processing for controlling a state of command acceptance according to, for example, the detection result acquired from the voice recognition unit 40. For example, the control unit 60 determines whether a command is being accepted. When the starting word is detected as a result of voice recognition in the voice recognition unit 40, the command turns unacceptable. Thereafter, when predetermined conditions are satisfied (after a lapse of a specific time), the command turns acceptable. A processing example of the control unit 60 will be specifically described later. The information processing device according to the present disclosure is provided for the voice recognition device 1 and includes at least the control unit 60.

The response unit 70 includes, for example, a speaker, a display, a communication device, and various drives and makes a response generated by the processing of the response generating unit 50. For example, in the foregoing example, the response unit 70 outputs (reproduces, for example, voice data with a speaker) information about “It will be fine tomorrow” by using response information provided from the response generating unit 50. The response is not limited a specific method. For example, a response may be a voice output, an image output, a motion of a movable part (e.g., a gesture by a motion of a mobile unit of a gesture mechanism), control on various switches, or various operations by an output of an operation signal.

The voice recognition device 1 according to the present embodiment is an integral configuration of devices constituting the foregoing units. The devices constituting the units may be separate configurations or partially integrated configurations. For example, storage devices constituting the starting word dictionary 20 and the command dictionary 30 may be installed on a cloud server. The devices may be connected by any methods including wire or wireless connection (communications).

### [Processing Example of Control Unit]

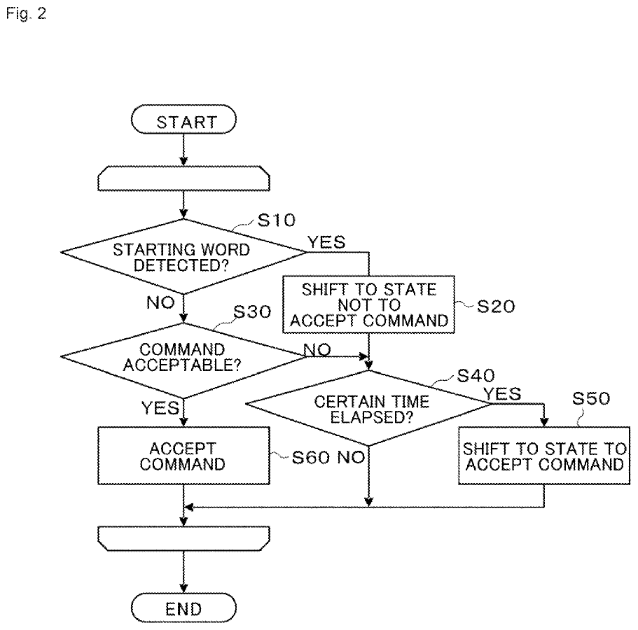

Referring to FIG. 2, a processing example of the control unit 60 according to the present embodiment will be described below. The order of processing can be changed unless a problem occurs in the processing. As described above, the voice recognition device 1 is a device that does not require a starting word when reacting to a voice, and accepts a command under normal conditions. In this state, the control unit 60 determines whether a starting word has been detected in the voice recognition unit 40 (step S10). For example, the control unit 60 makes the determination based on the detection result of the starting word acquired from the voice recognition unit 40.

In step S10, if it is determined that a starting word has been detected (YES), a state of command acceptance is shifted from an acceptable state to an unacceptable state (step S20). The control unit 60 shifts to an unacceptable state of commands by stopping, for example, the processing of the voice recognition unit 40. Thus, the voice recognition device 1 does not react to any commands (a reaction of “no action”). The response unit 70 may disable a response by stopping the processing of the response generating unit 50.

In step S10, if it is determined that no starting word has been detected (NO), the control unit 60 determines whether the state of command acceptance is an acceptable state (step S30). The determination is made on the assumption that a starting word has been detected in past processing and commands have not been acceptable.

After the processing of step S20 or if it is determined in step S30 that commands are not acceptable (NO), the control unit 60 determines whether a certain time (e.g., five seconds) has elapsed since the starting word (the last detected starting word) determined in step S10 is detected (step S40). The determination is made by using, for example, a timer function available to the voice recognition device 1.

In step S40, if it is determined that the certain time has elapsed (YES), the control unit 60 shifts to an acceptable state of commands (step S50). In step S40, if it is determined that the certain time has not elapsed (NO), the processing is terminated.

In step S30, if it is determined that commands are acceptable (YES), the control unit 60 keeps the acceptable state of commands, causes the voice recognition unit 40 to detect a word for a command (step S60), and then terminates the processing.

### [Use Environment Example of Voice Recognition Device]

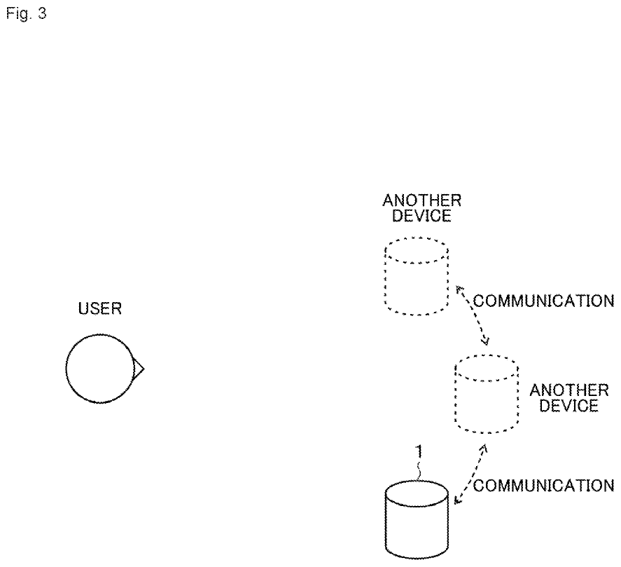

Referring to FIG. 3, a use environment example of the voice recognition device 1 will be described below. As illustrated in FIG. 3, the minimum configuration of the use environment of the voice recognition device 1 includes no devices (indicated by broken lines) other than the voice recognition device 1. In other words, the voice recognition device 1 can be used alone (react to a voice) and does not require communications with other devices when performing the foregoing processing.

As indicated by the broken lines in FIG. 3, other devices that start reactions in response to a starting word may be present in the same space (specifically, in a range where a voice can be collected with the voice recognition device 1) as the voice recognition device 1 (a device that reacts without a starting word). Other devices may be a plurality of devices as illustrated in FIG. 3. Communications may be present or absent between the voice recognition device 1 and other devices and among other devices. Furthermore, the voice recognition device 1 may be connected or unconnected to the server (not illustrated) of a cloud server or the like.

### [Basic Operation Example of Voice Recognition Device]

For example, the voice recognition device 1 does not react in the following case: It is assumed that in response to a user's voice, for example, “OK Google, play music,” “OK Google” registered as starting words in the starting word dictionary 20 is recognized. In this case, no response is made even if “Play music” registered as words for a command in the command dictionary 30 is correctly recognized. Moreover, no response is made also when a user's voice (for example, “Put soy source”) is not registered in the command dictionary 30.

For example, the voice recognition device 1 reacts in the following case: If a user says “Play music” registered as words for a command in the command dictionary 30, the starting word portion is not present (is not recognized), so that a response (operation) associated with the command “Play music” is returned.

In the voice recognition device 1 according to the present embodiment, if a user's voice includes the starting word of another device registered in the starting word dictionary 20, the control unit 60 performs control to prevent an operation from being performed in response to a voice until a certain time after the starting word is detected. If the user's voice does not include the starting word of another device, the control unit 60 performs control to conduct an operation in response to a voice. This can reduce malfunctions of the voice recognition device 1 and enable more reactions only to voices for the device. Specifically, when “starting word+command” is issued from a user to a device requiring a starting word, the voice recognition device 1 can be prevented from malfunctioning in response to the command.

In other words, malfunctions can be prevented in a device (voice recognition device 1) that does not require a starting word. In order to prevent malfunctions in devices that do not require a starting word, some devices start (end) voice recognition with presses on buttons or taps on screens. However, such a device (e.g., a device with a button for starting (ending) voice recognition) requires a user to manually operate the device or the screen, so that the user cannot operate the device when cooking with both hands or being located remote from the device. The voice recognition device 1 is user-friendly in the sense that the foregoing processing can be performed in such a case.

In the past, the main focus was to determine which one of devices capable of voice response is to be used for voice response, and it was assumed that a plurality of devices are linked with one another. In contrast, the voice recognition device 1 can perform the foregoing processing without communicating with other devices, thereby easily implementing malfunctions with a simple structure. Furthermore, the voice recognition device 1 determines whether to react to a voice only by detecting the presence or absence of the starting words of other devices, thereby more easily and simply preventing malfunctions as compared with the related art.

### 2. Second Embodiment

A second embodiment will be described below. The matters described in the first embodiment can be applied to other embodiments and a modification example unless otherwise mentioned. A voice recognition device according to the second embodiment is identical in configuration to the first embodiment and will be described with reference to FIG. 1. The second embodiment is different from the first embodiment in processing in the control unit 60 of FIG. 1. The other configurations are identical to those in the first embodiment.

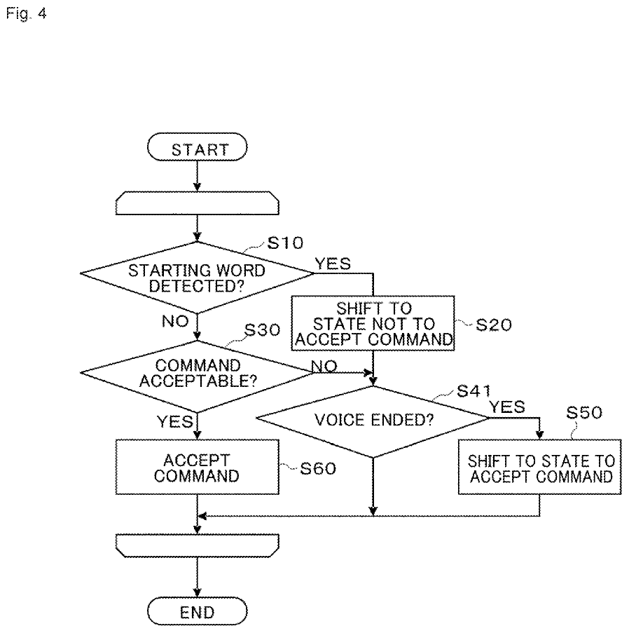

FIG. 4 is a flowchart for explaining a processing example of the control unit 60 according to the present embodiment. The control unit 60 according to the present embodiment is different in the processing of step S40 (see FIG. 2) described in the first embodiment. In the first embodiment, the control unit 60 shifts to an acceptable state of commands after a certain time since the last starting word is detected. In the present embodiment, the control unit 60 shifts to an acceptable state of commands at the end of a voice subsequent to a starting word (a voice assumed to be a command voice).

Specifically, as indicated in FIG. 4, after the processing of step S20 or if it is determined in step S30 that commands are not acceptable (NO), the control unit 60 determines whether a voice subsequent to (immediately following) a starting word has ended (step S41). The end of the voice is determined by using, for example, the detection of a voice section provided from a voice recognition unit 40 or using voice end determination (the results of detection of the voice section and determination of the end of the voice section).

In step S41, if it is determined that the voice has ended (YES), the control unit 60 shifts to a state to accept a state of command acceptance (step S50). In step S41, if it is determined that the voice has not ended (NO), the processing is terminated.

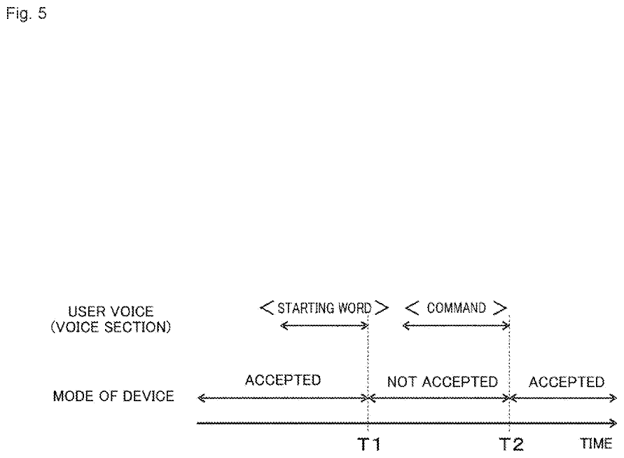

FIG. 5 is an explanatory drawing of a state shift example when a starting word and a command are uttered with a pause for breath. As indicated in FIG. 5, in this case, a state is controlled to accept a command until the starting word is detected (time T1). After the starting word is detected (time T1), the state is controlled not to accept a command until a voice (the command in FIG. 5) subsequent to the starting word ends (time T2). After the end of the voice subsequent to the starting word (time T2), the state is controlled to accept a command again.

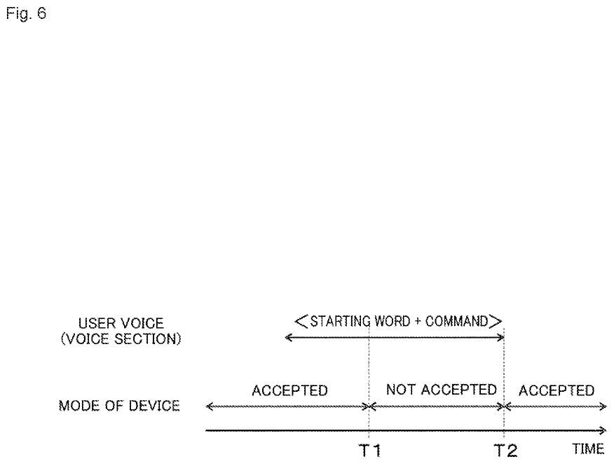

FIG. 6 is an explanatory drawing of a state shift example when a starting word and a command are uttered with one breath. As indicated in FIG. 6, also in this case, a state is controlled to accept a command until the starting word is detected (time T1). After the starting word is detected (time T1), the state is controlled not to accept a command until a voice (the command in FIG. 6) subsequent to the starting word ends (time T2). After the end of the voice subsequent to the starting word (time T2), the state is controlled to accept a command again. In FIGS. 5 and 6, a delay of the detection of the starting word and a delay of the determination of the end of the voice are not considered. In reality, a delay may occur. Specifically, the timing of a device mode shift may be slightly delayed from the timing of an actual user voice.

In a voice recognition device 1 according to the present embodiment, a time not to accept a command can be adaptively controlled according to the length of a command. For example, if a command is not accepted for a fixed time as described in the first embodiment, the end of a long voice (specifically, a command) subsequent to the starting word may be recognized. If a command is uttered to the voice recognition device 1 immediately after a command (starting word+command) to another device, the command may become unacceptable in a state not to accept a command. In the voice recognition device 1 according to the present embodiment, such a problem is prevented because a state is shifted to accept a command at the end of a voice subsequent to a starting word.

### 3. Third Embodiment

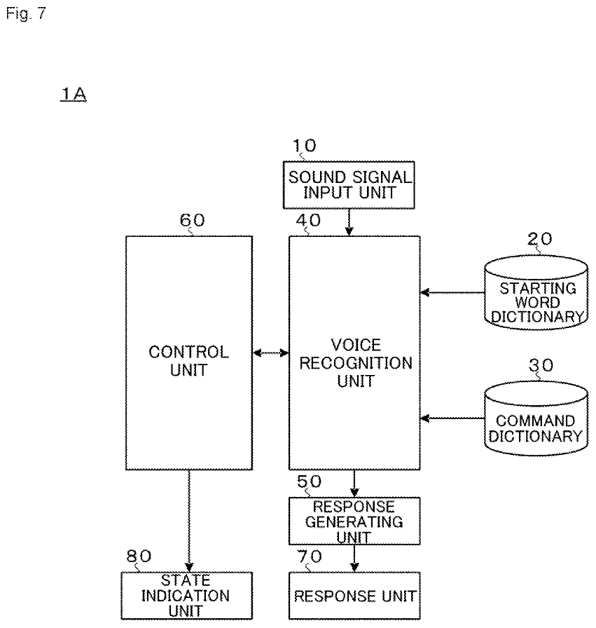

A third embodiment will be described below. FIG. 7 is a functional block diagram illustrating a configuration example of a voice recognition device (voice recognition device 1A) according to the third embodiment. In the first embodiment, after the starting word is detected, the behavior of the voice recognition device 1 in a state not to accept a command is “no action.” In this case, any problems do not occur if a user is not speaking to the device of the user. However, if a starting word is erroneously detected, a voice (speech) to the device is not accepted. In the absence of a response, the user cannot understand why no response is made. Thus, in the voice recognition device 1A according to the present embodiment, if a user's voice includes the starting word, a control unit 60 causes a state indication unit 80 in FIG. 7 to indicate that no reaction is to occur in response to a user's voice until a certain time after the last starting word is detected. Specifically, the state indication unit 80 is caused to indicate a state of command acceptance. The voice recognition device 1A according to the present embodiment is identical to the voice recognition device 1 according to the first embodiment except for the provision of the state indication unit 80.

The state indication unit 80 includes, for example, an LED (Light Emitting Diode), a display device such as an image display device, the mobile unit of a gesture mechanism, and an indicator such as a voice output device (a device capable of indicating something to a user). A notification with sound may interfere with voice recognition of commands to other devices. Thus, the state indication unit 80 preferably indicates a notification using means other than sound. Moreover, the state indication unit 80 may include the same device as a response unit 70. This can simplify the configuration of the voice recognition device 1A. For example, the state indication unit 80 indicates a state of command acceptance to a user under the control of the control unit 60.

If the state indication unit 80 is an LED, for example, a color or a pattern (in the case of multiple LEDs) is displayed to inform the user that the current mode does not accept a response (or accepts a response). If the state indication unit 80 is an image display device, for example, characters and pictures are displayed on a screen to inform the user of the current mode. For example, if the voice recognition device 1A is a device having a gesture mechanism with a face, a neck, and hands like a human or animal robot, the mobile unit of the gesture mechanism may be moved to indicate a state not to accept (or to accept) a command by shaking the head of the user or making a gesture with a hand. Thus, the state indication unit 80 may provide any indication if the user can be informed of whether a command is acceptable or not. Gestures in the present specification include, for example, all the expressions of external dynamic changes including the motions of the eyelids and tongue of a robot in addition to body and hand gestures with motions of joints.

The voice recognition device 1A according to the present embodiment can inform the user that the device is placed in a state not to respond (or to respond) to the user. Thus, even if a response is not made because of erroneous detection of a starting word, the user can be informed of “No response because the starting word of another device has been erroneously recognized,” thereby improving usability.

### 4. Fourth Embodiment

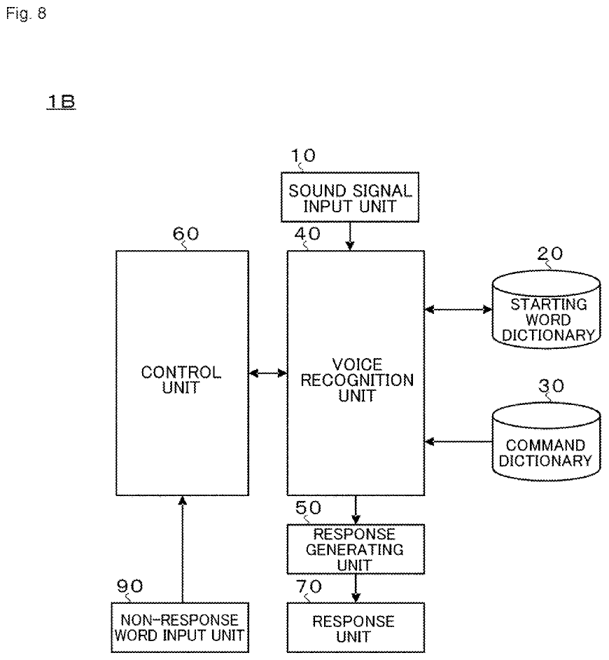

A fourth embodiment will be described below. FIG. 8 is a functional block diagram illustrating a configuration example of a voice recognition device (voice recognition device 1B) according to the fourth embodiment. In the first embodiment, the starting words of other devices are registered in advance in the starting word dictionary 20. However, the preset starting words may insufficiently cover devices. For example, additional devices may be provided or starting words may be added for other devices by software update or the like. The voice recognition device 1 cannot support devices operating with unknown starting words. In some cases, a user may ask for something from a family member by “name+command.” For example, if the user asks “Taro, play music” with the name of a family member, the voice recognition device 1 may malfunction.

Thus, in order to support such a case in the present embodiment, words not to react with the voice recognition device (non-response words), for example, unknown names may be additionally set by using a non-response word input unit 90 of FIG. 8. A non-response word is a trigger (non-response trigger) including words for disabling a reaction to a voice. The starting word (starting trigger) is included in the non-response word (non-response trigger). The voice recognition device 1B according to the present embodiment is identical to the voice recognition device 1 according to the first embodiment except for the provision of the non-response word input unit 90.

The non-response word input unit 90 includes, for example, input devices such as a touch panel, a keyboard, and a microphone. The non-response word input unit 90 may be implemented by voice input using devices constituting a sound signal input unit 10. This can simplify the configuration of the voice recognition device 1B. For example, the non-response word input unit 90 inputs, under the control of a control unit 60, non-response words to be additionally registered in a starting word dictionary 20.

The non-response word input unit 90 may include a communication device. For example, words may be additionally registered by the programs or the like of a terminal device (not illustrated) connected to the voice recognition device 1B via a communication device. Specifically, additional words (non-response words) may be registered from, for example, a smartphone application linked to the voice recognition device 1B. If additional words are inputted as, for example, characters, the words are inputted in phonetic representations or typical character representations or the like.

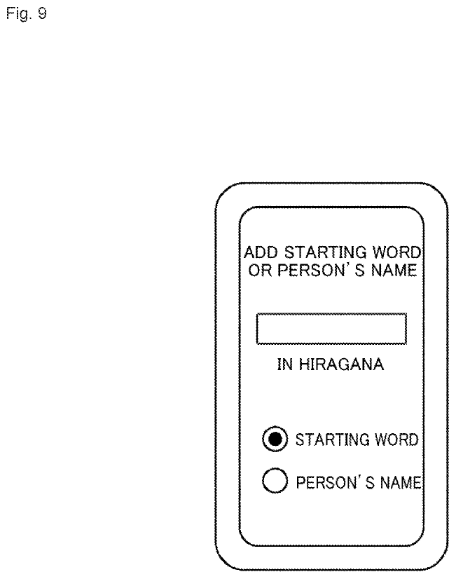

FIG. 9 illustrates a configuration example of a word addition screen. For example, as illustrated in FIG. 9, words are preferably inputted and registered in phonetic representations (the representations of characters indicating the reading of Japanese such as “Taro”). Thus, pronunciations can be recognized to eliminate erroneous reading during detection. In FIG. 9, items (radio buttons) for selecting a starting word or a person's name may be omitted. Non-response words inputted by the non-response word input unit 90 are additionally registered in the starting word dictionary 20 as information indicating the representation of non-response settings by the control unit 60.

At this point, if additional words are identical to non-response words (e.g., starting words) registered in the starting word dictionary 20, the user may be informed via an input screen or the like that the words have been already set when being added. This can prevent double registration. If additional words are identical to registered words for commands in a command dictionary 30, the user may be informed via an input screen or the like that additional words are identical to the words for commands, or the registration may be disabled. This can eliminate a problem that registered words for commands in the command dictionary 30 cannot be recognized.

If the voice recognition device 1B is connected to a cloud server, the server may be informed of words additionally registered as non-response words (e.g., starting words) in the starting word dictionary 20, and if identical non-response words have been registered in many devices, the words may be automatically registered as non-response words and distributed to the devices. Thus, non-response words can be efficiently set in consideration of the usage situations of a plurality of users.

In the voice recognition device 1B according to the present embodiment, any non-response words not to react with the voice recognition device 1B can be additionally set in the starting word dictionary 20 as appropriate, thereby preventing malfunctions in various cases.

### 5. Fifth Embodiment

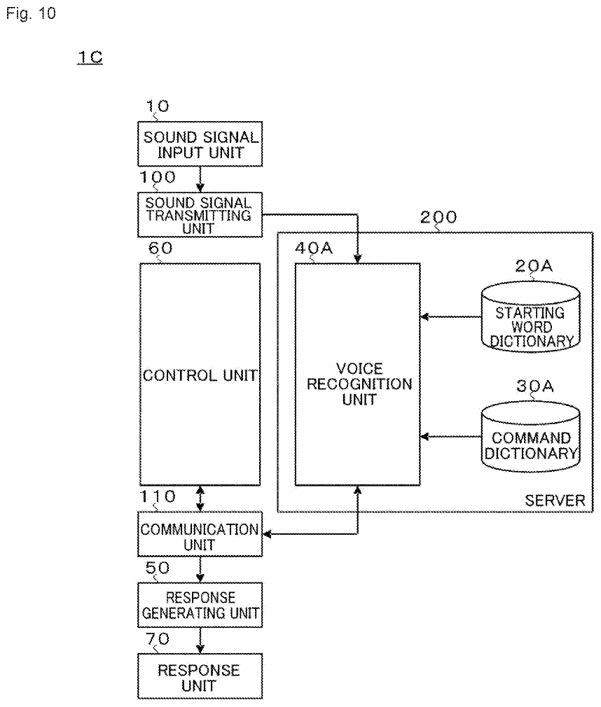

A fifth embodiment will be described below. FIG. 10 is a functional block diagram illustrating a configuration example of a voice recognition device (voice recognition device 1C) according to the fifth embodiment. The first embodiment described a configuration example of the voice recognition device 1 including the starting word dictionary 20, the command dictionary 30, and the voice recognition unit 40. The voice recognition device 1C according to the present embodiment includes a sound signal transmitting unit 100 and a communication unit 110 and is different from the first embodiment in the use of a starting word dictionary 20A, a command dictionary 30A, and a voice recognition unit 40A that are provided on a server 200, e.g., a cloud server. Other configurations are identical to those of the voice recognition device 1 according to the first embodiment.

In other words, in the voice recognition device 1C, the starting word dictionary 20, the command dictionary 30, and the voice recognition unit 40 are replaced with the sound signal transmitting unit 100 and the communication unit 110. A sound signal converted by a sound signal input unit 10 is provided to the sound signal transmitting unit 100. The sound signal transmitting unit 100 includes, for example, a communication device connectable to a network, e.g., the Internet. The sound signal transmitting unit 100 transmits a sound signal acquired from the sound signal input unit 10, to the server 200 (another information processing device).

In this configuration, the server 200 is composed of, for example, a personal computer and includes the starting word dictionary 20A, the command dictionary 30A, and the voice recognition unit 40A. The starting word dictionary 20A, the command dictionary 30A, and the voice recognition unit 40A have the same functional configurations as the starting word dictionary 20, the command dictionary 30, and the voice recognition unit 40, and a detailed explanation thereof is omitted. The sound signal acquired by the server 200 is provided to the voice recognition unit 40A and is processed therein. Specifically, the server 200 includes the voice recognition unit 40A (voice recognizer) that uses the starting word dictionary 20A and the command dictionary 30A. The sound signal is transmitted from the voice recognition device 1C to the server 200, enabling voice recognition in the server 200. The recognition result in the voice recognition unit 40A is returned to the local (voice recognition device 1C) side, which has transmitted the sound signal, and is used on the local side. The server 200 is configured so as to be connected to a plurality of voice recognition devices 1C.

The communication unit 110 of the voice recognition device 1C includes, for example, a communication device connectable to a network, e.g., the Internet. For the communication unit 110 and the sound signal transmitting unit 100, a common communication device may be shared or different communication devices may be used. The communication unit 110 communicates with the server 200 and acquires the recognition result of the voice recognition unit 40A on the server 200.

A control unit 60 and a response generating unit 50 each perform the same processing as described in the first embodiment (processing based on the recognition result in the voice recognition unit 40A) with the voice recognition unit 40A via the communication unit 110.

As described above, the starting word dictionary 20A, the command dictionary 30A, and the voice recognition unit 40A on the server 200 are used instead of the starting word dictionary 20, the command dictionary 30, and the voice recognition unit 40, thereby downsizing the voice recognition device 1C, reducing a processing load, and increasing a storage capacity.

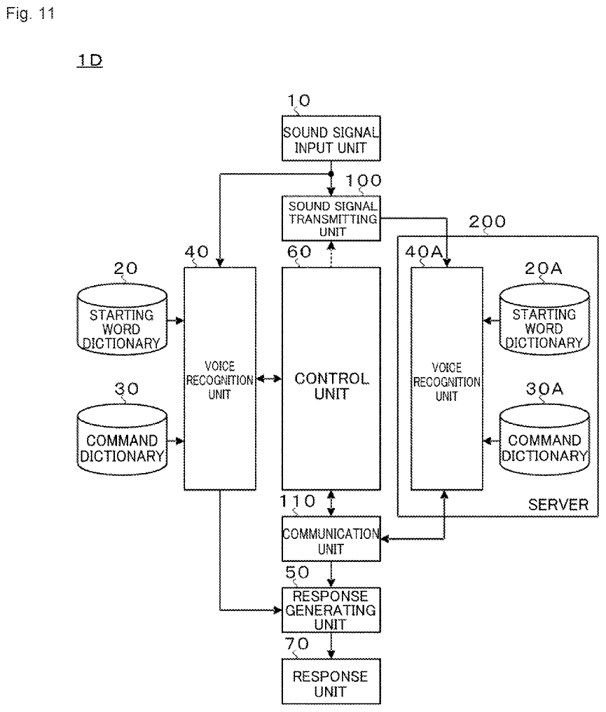

FIG. 11 is a functional block diagram illustrating another configuration example of a voice recognition device (voice recognition device 1D) according to the present embodiment. As illustrated in FIG. 11, the voice recognition device 1D has a combined configuration of the voice recognition device 1 according to the first embodiment and the voice recognition device 1C. Specifically, the voice recognition device 1D includes the sound signal transmitting unit 100 and the communication unit 110 along with the starting word dictionary 20, the command dictionary 30, and the voice recognition unit 40. Thus, the voice recognition device 1D is configured to use the voice recognition functions of the local (voice recognition device 1D) side and the server 200 in combination.

In this configuration, words in the starting word dictionary 20 and the command dictionary 30 on the local side may overlap with words in the starting word dictionary 20A and the command dictionary 30A on the server 200, or a subset of dictionaries on the server 200 may be used. The starting word dictionary 20A and the command dictionary 30A on the server 200 are specifically configured with larger storage capacities than the starting word dictionary 20 and the command dictionary 30 on the local side, enabling the registration of a larger number of words.

In consideration of a voice recognition load, a command dictionary size, and a response delay, the control unit 60 switches the use of the starting word dictionary 20 and the command dictionary 30 on the local side and the use of the starting word dictionary 20A and the command dictionary 30A on the server side.

For example, if a command frequently uttered by a user in the past is present only in the command dictionary 30A on the server side, it may be determined that the command would be frequently used in the future, and the command may be stored in the command dictionary 30 on the local side of the user. If the storage and memory on the local side are restricted, a word for a command with a low frequency of utterance may be deleted in the command dictionary 30 on the local side and may be recognized only in the command dictionary 30A on the server side. Accordingly, a command with a high frequency of utterance may be added to the command dictionary 30 on the local side. In this way, registered words may be optionally switched between the starting word dictionary 20 and the command dictionary 30 on the local side and the starting word dictionary 20 and the command dictionary 30 on the server 200. The switching may be performed by units (e.g., a processing device on the server 200) other than the control unit 60.

Subsequently, the control unit 60 determines whether to make a response and a command for response with reference to the recognition results of the voice recognition unit 40 on the local side and the voice recognition unit 40A on the server 200. For example, if no match is found with starting words or commands in the voice recognition unit 40 on the local side, a sound signal is transmitted to the voice recognition unit 40A on the server 200 to achieve word recognition. The voice recognition unit 40 on the local side and the voice recognition unit 40A on the server 200 may be operated at the same time, and if the recognition result of a match with a starting word or a command is obtained from one of the voice recognition units, the recognition result may be used. If matches are found from both of the voice recognition units, for example, the result of the local side has higher priority.

In this way, the voice recognition device 1D according to the present embodiment personalizes (optimizes) and updates the starting word dictionary 20 and the command dictionary 30, thereby constructing an efficient data structure suitable for usage situations.

### 6. Sixth Embodiment

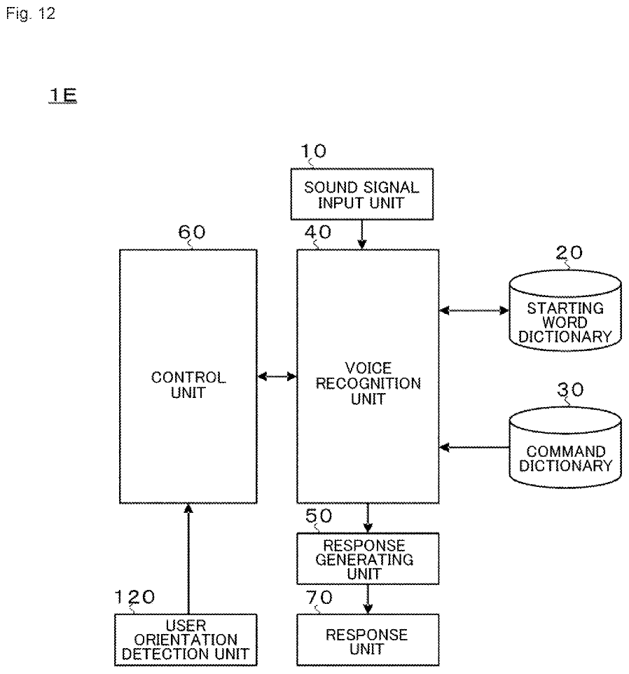

A sixth embodiment will be described below. FIG. 12 is a functional block diagram illustrating a configuration example of a voice recognition device (voice recognition device 1E) according to the sixth embodiment. In the first embodiment, if the detection of a starting word fails or in the presence of other devices operable without a starting word, a response may be made to a voice of other devices. Thus, in the present embodiment, a user orientation detection unit 120 is used to detect the orientation of a user, and whether to respond to a user's voice is determined according to the detection result. The voice recognition device 1E according to the present embodiment is identical to the voice recognition device 1 according to the first embodiment except for the provision of the user orientation detection unit 120.

The user orientation detection unit 120 includes, for example, an imaging device. The user orientation detection unit 120 generates image (including a moving image) information about the use environment of the voice recognition device 1E and outputs the information. A control unit 60 acquires the image information from the user orientation detection unit 120. In this case, the appearances of other devices operating in response to a voice are registered (stored in a storage device or the like) in advance by a user or a developer, and the control unit 60 can acquire appearance information indicating the appearances. By using the image information acquired from the user orientation detection unit 120 and the appearance information, the control unit 60 determines that another device is detected in the use environment of the voice recognition device 1E and the user speaks while watching the device. In this case, the control unit 60 does not react even if no starting word is detected. Thus, when the user speaks to another device, a reaction of the voice recognition device 1E can be prevented on the assumption that the user speaks to another device.

In some cases, a plurality of persons are detected in an image captured by the imaging device, and thus a speaker cannot be identified among the persons. Thus, the user orientation detection unit 120 may further have the function of estimating a sound source position (at least one of a direction and a distance). For example, the user orientation detection unit 120 can be configured with an imaging device a plurality of microphones or the like. If the device has a plurality of microphones, the sound source position can be estimated. In this case, the control unit 60 may control an operation such that the voice recognition device 1E does not react when a person located in the direction of a command voice does not watch the voice recognition device 1E. Thus, the voice recognition device 1E can react only when a user assumed to be a speaker faces the user's own device. The estimation of the sound source position is not limited thereto. Other known methods are also applicable.

In the voice recognition device 1E according to the present embodiment, whether to react is determined in consideration of the orientation of the user, thereby further preventing malfunctions. Even if other devices operating without a starting word are present in addition to the voice recognition device 1E in the same space, malfunctions can be prevented. Furthermore, by specifying the sound source position, a speaker can be identified to prevent malfunctions even if a plurality of persons are present in the same space.

### 7. Modification Example

Although embodiments of the present disclosure have been described above in detail, the present disclosure is not limited to the above-described embodiments and various modifications based on the technical spirit of the present disclosure can be made. For example, many variations such as those described hereinafter are possible. One or more of the forms of the variations described hereinafter may be selected as desired and combined as appropriate. The configurations, methods, steps, shapes, materials, numerical values, and the like of the foregoing embodiments can be combined with each other without departing from the gist of the present disclosure.

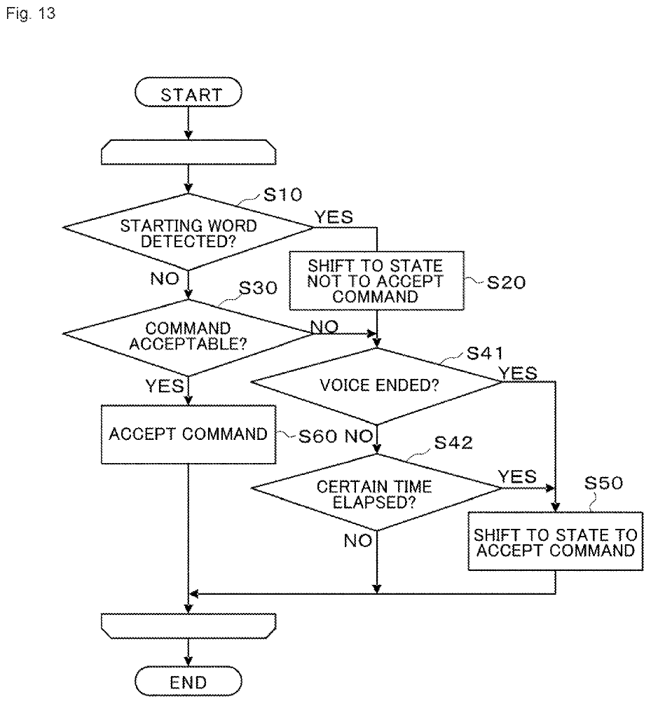

For example, two or more of the embodiments can be used in combination as described below. FIG. 13 is a flowchart for explaining a processing example of the control unit according to a modification example. In the case of processing in the control unit 60 described in the second embodiment, the following situations may occur: If a termination is not determined because of an error in the detection of a voice section, if a user's voice other than commands continues subsequently to a starting word, or if a conversation or the like other than a user's voice continues, the end of the detection of a voice section may be undetermined for a long time. In this case, a shift to a state to accept a command is not made for a long time. Thus, in the present modification example, when shifting to a state to accept a command, both of the detection of a voice section described in the second embodiment and the lapse of a certain time described in the first embodiment are used. Other configurations are identical to those in the second embodiment.

Specifically, as indicated in FIG. 13, after the processing of step S20 or if it is determined in step S30 that commands are not acceptable (NO), the control unit 60 determines whether a voice subsequent to a starting word has ended (step S41). In step S41, if it is determined that the voice has ended (YES), the control unit 60 shifts to a state to accept a state of command acceptance (step S50).

In step S41, if it is determined that the has not ended (NO), the control unit 60 determines whether a certain time has elapsed since the last detected starting word is detected (step S42). In step S42, if it is determined that the certain time has elapsed (YES), the control unit 60 shifts to a state to accept a state of command acceptance (step S50). In step S42, if it is determined that the certain time has not elapsed (NO), the processing is terminated.

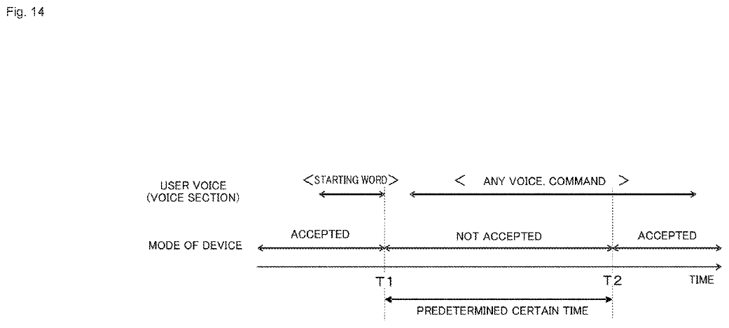

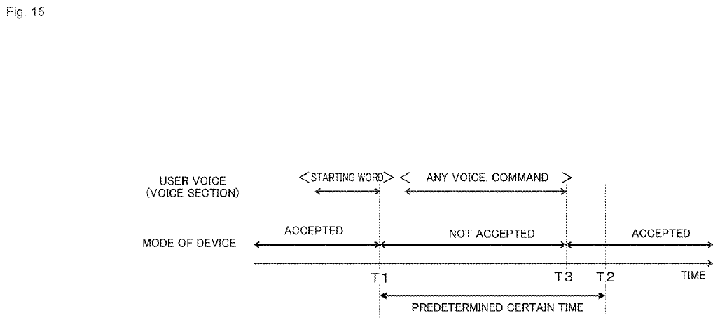

Thus, for example, as indicated in FIG. 14, if a voice subsequent to a starting word is continuously detected longer than the lapse of a predetermined certain time (a time between times T1 and T2), the control unit 60 shift to a state to accept a command at a time (time T2) after the certain time. Moreover, for example, as indicated in FIG. 15, if a voice subsequent to the starting word is ended before the lapse of the predetermined certain time, the control unit 60 shift to a state to accept a command at the end time (time T3) of the voice. In this way, the present modification example can properly prevent erroneous detection without the foregoing situations.

For example, in the foregoing embodiments, the sound of a user's voice is detected (recognized) as a user's expression in the voice recognition unit 40. Sounds other than user's voices, for example, other voices, clapping sound, and the sound of a whistle may be detected. In addition to voices, for example, a gesture of the user may be detected. If sounds other than user's voices are detected, a non-response word (starting word) and a word for a command may correspond to the representations of detection. Alternatively, words in mixed representations may be detected. Moreover, a word for non-response detection and a word for a command may be detected in different kinds of representations. These representations can support a combined use with various devices. If representations by gestures are detected, the sound signal input unit 10 may be replaced with, for example, a captured-image input unit including an imaging device, and a gesture may be detected from a captured image. A gesture can be registered and detected by using a known method.

The present disclosure can also be configured as follows:

(1)

An information processing device including a control unit that performs control not to react to a user's expression, if the user's expression includes a representation of a predetermined non-response setting, until predetermined setting conditions are satisfied and to react to the user's expression if the user's expression does not include the representation of the non-response setting.

(2)

The information processing device according to (1), wherein the representation of the non-response setting is a starting trigger required when an instruction is provided to start a reaction to a user's expression in other devices.

(3)

The information processing device according to (1) or (2), wherein a reaction to the user's expression does not require the starting trigger for providing an instruction to start a reaction.

(4)

The information processing device according to any one of (1) to (3), wherein the control by the control unit does not require communications with other devices.

(5)

The information processing device according to any one of (1) to (4), wherein the expression is made by a sound or a gesture.

(6)

The information processing device according to any one of (1) to (5), wherein the setting conditions are satisfied after a lapse of a predetermined certain time since an end of the representation of the non-response setting.

(7)

The information processing device according to any one of (1) to (5), wherein the setting conditions are satisfied after an end of a user's expression subsequent to the representation of the non-response setting.

(8)

The information processing device according to any one of (1) to (7), wherein if the user's expression includes the representation of the non-response setting, the control unit causes a state indication unit to indicate that no reaction occurs to the user's expression until the predetermined setting conditions are satisfied.

(9)

The information processing device according to (8), wherein the state indication unit provides the indication by display through a display device or a gesture using a gesture mechanism.

(10)

The information processing device according to any one of (1) to (9), wherein any representation of the non-response setting is allowed to be additionally set.

(11)

The information processing device according to any one of (1) to (10), wherein the control unit performs control to acquire information indicating the user's expression and the representation of the non-response setting and information for specifying a predetermined response,
determine whether the user's expression includes the representation of the non-response setting by using information indicating the user's expression and information indicating the representation of the non-response setting, and respond to a representation if the user's expression includes the representation indicating a response specified by the information for specifying the response, by using the information indicating the user's expression and the information indicating the representation of the non-response setting.
   (12)

The information processing device according to (11), wherein the information indicating the representation of the non-response setting and the information for specifying the response are stored in at least one of storage devices on a local server and a cloud server according to a frequency of use.

(13)

The information processing device according to any one of (1) to (12), wherein if the representation of the non-response setting is not included in the user's expression, the control unit specifies an orientation of the user and determines whether to react to the user's expression according to the specified orientation.

(14)

The information processing device according to (13), wherein the control unit determines whether the user faces another device, and performs control not to react to the user's expression if it is determined that the user faces another device and to react to the user's expression if it is determined that the user does not face another device.

(15)

The information processing device according to (13) or (14), wherein the control unit specifies the user by estimating a sound source position, determines whether the specified user faces the user's own device, and performs control not to react to the user's expression if it is determined that the user does not face the user's own device and to react to the user's expression if it is determined that the user faces the user's own device.

(16)

An information processing method in which a control unit performs control not to react to a user's expression, if the user's expression includes a representation of a predetermined non-response setting, until predetermined setting conditions are satisfied and to react to the user's expression if the user's expression does not include the representation of the non-response setting.

(17)

A program that causes a computer to perform an information processing method in which a control unit performs control not to react to a user's expression, if the user's expression includes a representation of a predetermined non-response setting, until predetermined setting conditions are satisfied and to react to the user's expression if the user's expression does not include the representation of the non-response setting.

### REFERENCE SIGNS LIST

1, 1A, 1B, 1C, 1D, 1E Voice recognition device

10 Sound signal input unit

20 Starting word dictionary

30 Command dictionary

40 Voice recognition unit

50 Response generating unit

60 Control unit

70 Response unit

80 State indication unit

90 Non-response word input unit

100 Sound signal transmitting unit

110 Communication unit

120 User orientation detection unit

1. An information processing device comprising a control unit that performs control not to react to a user's expression, if the user's expression includes a representation of a predetermined non-response setting, until predetermined setting conditions are satisfied and to react to the user's expression if the user's expression does not include the representation of the non-response setting.

2. The information processing device according to claim 1, wherein the representation of the non-response setting is a starting trigger required when an instruction is provided to start a reaction to a user's expression in other devices.

3. The information processing device according to claim 1, wherein a reaction to the user's expression does not require the starting trigger for providing an instruction to start a reaction.

4. The information processing device according to claim 1, wherein the control by the control unit does not require communications with other devices.

5. The information processing device according to claim 1, wherein the expression is made by a sound or a gesture.

6. The information processing device according to claim 1, wherein the setting conditions are satisfied after a lapse of a predetermined certain time since an end of the representation of the non-response setting.

7. The information processing device according to claim 1, wherein the setting conditions are satisfied after an end of a user's expression subsequent to the representation of the non-response setting.

8. The information processing device according to claim 1, wherein if the user's expression includes the representation of the non-response setting, the control unit causes a state indication unit to indicate that no reaction occurs to the user's expression until the predetermined setting conditions are satisfied.

9. The information processing device according to claim 8, wherein the state indication unit provides the indication by display through a display device or a gesture using a gesture mechanism.

10. The information processing device according to claim 1, wherein any representation of the non-response setting is allowed to be additionally set.

11. The information processing device according to claim 1, wherein the control unit performs control to acquire information indicating the user's expression and the representation of the non-response setting and information for specifying a predetermined response,
determine whether the user's expression includes the representation of the non-response setting by using information indicating the user's expression and information indicating the representation of the non-response setting, and respond to a representation if the user's expression includes the representation indicating a response specified by the information for specifying the response, by using the information indicating the user's expression and the information indicating the representation of the non-response setting.

12. The information processing device according to claim 11, wherein the information indicating the representation of the non-response setting and the information for specifying the response are stored in at least one of storage devices on a local server and a cloud server according to a frequency of use.

13. The information processing device according to claim 1, wherein if the representation of the non-response setting is not included in the user's expression, the control unit specifies an orientation of the user and determines whether to react to the user's expression according to the specified orientation.

14. The information processing device according to claim 13, wherein the control unit determines whether the user faces another device, and performs control not to react to the user's expression if it is determined that the user faces another device and to react to the user's expression if it is determined that the user does not face another device.

15. The information processing device according to claim 13, wherein the control unit specifies the user by estimating a sound source position, determines whether the specified user faces the user's own device, and performs control not to react to the user's expression if it is determined that the user does not face the user's own device and to react to the user's expression if it is determined that the user faces the user's own device.

16. An information processing method in which a control unit performs control not to react to a user's expression, if the user's expression includes a representation of a predetermined non-response setting, until predetermined setting conditions are satisfied and to react to the user's expression if the user's expression does not include the representation of the non-response setting.

17. A program that causes a computer to perform an information processing method in which a control unit performs control not to react to a user's expression, if the user's expression includes a representation of a predetermined non-response setting, until predetermined setting conditions are satisfied and to react to the user's expression if the user's expression does not include the representation of the non-response setting.
